(19) United States
(12) Patent Application Publication
(10) Pub. No.: US 2026/0237939 A1
(43) Pub. Date: Aug. 13, 2026

(54) ELECTRICAL CONNECTOR HAVING CABLE MANAGEMENT

(71) Applicant: TE Connectivity Solutions GmbH, Schaffhausen (CH)

(72) Inventors: Po Wei Lu, Fremont, CA (US); Jeffery Walter Mason, Middletown, PA (US)

(21) Appl. No.: 19/048,180

(22) Filed: Feb. 7, 2025

(51) Int. Cl. H01R 13/58

(52) U.S. Cl. CPC H01R 13/5829

(57) ABSTRACT

A plug connector includes a plug housing that includes a mating end and a cable end. The plug housing includes a contact housing at the mating end and a cable housing at the cable end. The plug connector includes a cable assembly coupled to the cable housing. The cable assembly includes cables extending from the cable end of the plug housing in a cable exit direction. The plug connector includes a contact assembly coupled to the contact housing. The contact assembly includes an array of contacts. Each contact includes a mating end and a terminating end. The mating end is configured to be mated with a mating connector. The terminating end is configured to be terminated to an end of a conductor of the corresponding cable. The cable housing is pivotably coupled to the contact housing to change the cable exit direction relative to the mating end.

### BACKGROUND OF THE INVENTION

The subject matter herein relates generally to plug connectors.

Electrical connectors are used to electrically connect various components within a communication system. Some systems use receptacle connectors, which may be mounted to a circuit board, and plug connectors, which may be provided at ends of cables. The cables extend from the plug connector to another component. Routing of the cables may be difficult, particularly in tight spaces with other components around the connectors. The installer may bend the cables beyond a bend limit of the cables, which may damage the cables or negatively affect SI performance of the cables.

There is a need for cable management of cables exiting electrical connectors.

### BRIEF DESCRIPTION OF THE INVENTION

In one embodiment, a plug connector is provided and includes a plug housing that includes a mating end and a cable end. The plug housing includes a contact housing at the mating end and a cable housing at the cable end. The plug connector includes a cable assembly coupled to the cable housing. The cable assembly includes cables extending from the cable end of the plug housing in a cable exit direction. The plug connector includes a contact assembly coupled to the contact housing. The contact assembly includes an array of contacts. Each contact includes a mating end and a terminating end. The mating end is configured to be mated with a mating connector. The terminating end is configured to be terminated to an end of a conductor of the corresponding cable. The cable housing is pivotably coupled to the contact housing to change the cable exit direction relative to the mating end.

In another embodiment, a plug connector is provided and includes a plug housing that includes a mating end and a cable end. The plug housing includes a contact housing at the mating end and a cable housing at the cable end. The cable housing is pivotably coupled to the contact housing to change an angular orientation of the cable housing relative to the contact housing. The plug connector includes a cable assembly coupled to the cable housing. The cable assembly includes cables extending from the cable end of the plug housing in a cable exit direction based on the angular orientation of the cable housing relative to the contact housing. The plug connector includes a contact assembly coupled to the contact housing. The contact assembly includes an array of contacts. Each contact includes a mating end and a terminating end. The mating end is configured to be mated with a mating connector. The terminating end is configured to be terminated to an end of a conductor of the corresponding cable. The plug connector includes a locking mechanism operably coupled to at least one of the contact housing and the cable housing to fix the cable housing relative to the contact housing at the locked angular orientation.

In a further embodiment, plug connector is provided and includes a plug housing that includes a mating end and a cable end. The plug housing includes a contact housing at the mating end and a cable housing at the cable end. The contact housing includes hubs at opposite sides of the contact housing. The cable housing includes pivot mechanisms that extend from opposite sides of the cable housing. The pivot mechanisms are pivotably coupled to the hubs to allow pivoting of the cable housing to change an angular orientation of the cable housing relative to the contact housing. The plug connector includes a cable assembly coupled to the cable housing. The cable assembly includes cables extending from the cable end of the plug housing in a cable exit direction based on the angular orientation of the cable housing relative to the contact housing. The plug connector includes a contact assembly coupled to the contact housing. The contact assembly includes an array of contacts. Each contact includes a mating end and a terminating end. The mating end configured to be mated with a mating connector. The terminating end is configured to be terminated to an end of a conductor of the corresponding cable. The cable housing is pivotably coupled to the contact housing to change the cable exit direction relative to the mating end.

### BRIEF DESCRIPTION OF THE DRAWINGS

FIG. 1 illustrates an electrical connector system in accordance with an exemplary embodiment.

FIG. 2 is a front perspective view of the plug connector in accordance with an exemplary embodiment.

FIG. 3 is a rear perspective view of a portion of the plug housing of the plug connector showing the cable housing in a first position relative to the contact housing in accordance with an exemplary embodiment.

FIG. 4 is a rear perspective view of a portion of the plug housing of the plug connector showing the cable housing in a second position relative to the contact housing in accordance with an exemplary embodiment

FIG. 5 is a rear perspective view of a portion of the plug housing of the plug connector showing the cable housing in a third position relative to the contact housing in accordance with an exemplary embodiment.

FIG. 6 shows an exemplary embodiment of the electrical connector system in accordance with an exemplary embodiment.

FIG. 7 is a top view of a portion of the plug connector showing the locking mechanism in accordance with an exemplary embodiment.

FIG. 8 is a perspective view of a portion of the plug connector showing the locking mechanism in accordance with an exemplary embodiment.

FIG. 9 is a rear perspective view of a portion of the plug housing of the plug connector in accordance with an exemplary embodiment.

FIG. 10 is a top view of a portion of the plug connector shown in FIG. 9 in accordance with an exemplary embodiment.

### DETAILED DESCRIPTION OF THE INVENTION

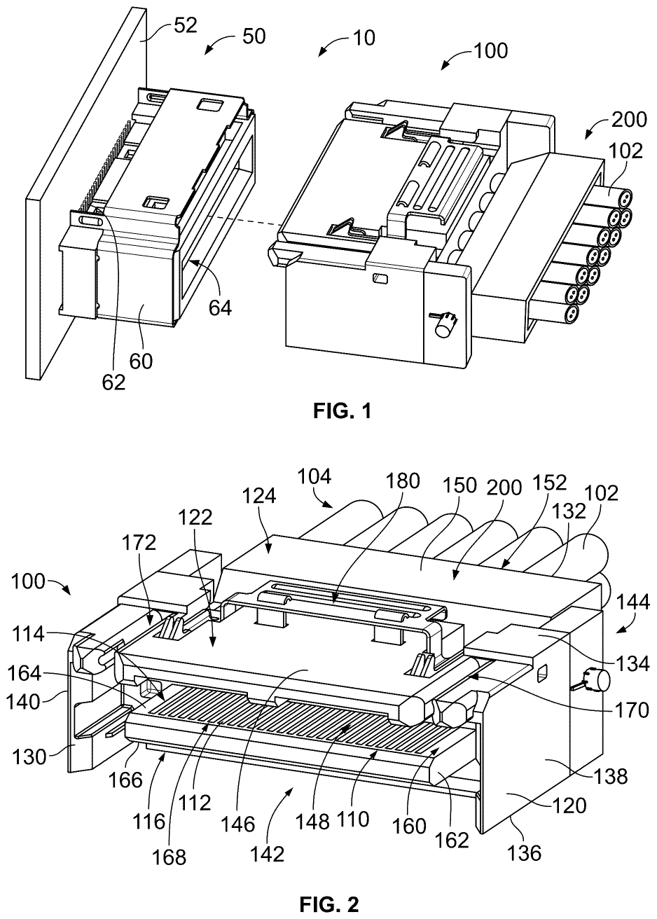

FIG. 1 illustrates an electrical connector system 10 in accordance with an exemplary embodiment. The electrical connector system 10 includes a plug connector 100 and a mating connector 50 that receives the plug connector 100. In an exemplary embodiment, the plug connector 100 is a cable connector having a plurality of cables 102 exiting the plug connector 100.

In various embodiments, the mating connector 50 is a receptacle connector and referred to hereinafter as a receptacle connector 50. In the illustrated embodiment, the receptacle connector 50 is mounted to a circuit board 52. However, in alternative embodiments, the receptacle connector 50 may be a cable connector. The mating connector 50 may be a header connector mounted to a fixed structure.

In an exemplary embodiment, the plug connector 100 has a cable management device 200 for managing the cables 102. The cable management device 200 is used to route the cables 102 from the plug connector 100. For example, the cable management device 200 may control the cable exit direction of the cables 102. The cable management device 200 is variably positionable to change the cable exit direction. For example, the cable management device 200 may be positioned to allow straight cable exit from the plug connector 100 relative to the mating direction or may be angled, such as at approximately 15° or 30° or 45° or 60° or 75 ° or 90° or other angular orientations to allow angled cable exit from the plug connector 100 relative to the mating direction. The cable management device 200 may be used to limit or control cable bending of the cables 102 exiting the plug connector 100, such as to prevent damage to the cables 102 and/or to prevent SI performance degradation from overbending of the cables 102. The cable management device 200 improves user experience and prevents excessive cable bending by providing flexible cable transition from the plug connector 100.

In an exemplary embodiment, the receptacle connector 50 is coupled to the circuit board 52. The receptacle connector 50 includes a receptacle connector housing 60 holding a plurality of receptacle connector contacts 62. The connector housing 60 may be mounted directly to the circuit board 52. The receptacle connector contacts 62 may be terminated to the circuit board 52, such as being soldered or press fit to conductors of the circuit board 52.

In an exemplary embodiment, the receptacle connector housing 60 includes a slot or receptacle 64 at a mating end of the receptacle connector housing 60 that receives the plug connector 100. The receptacle connector contacts 62 are arranged within the receptacle 64 for mating with the plug connector 100. The receptacle 64 is elongated, such as being rectangular shaped. The receptacle 64 may include a card slot. The receptacle connector contacts 62 may be located in one or more rows within the receptacle 64, such as along the top and the bottom of the receptacle 64. In various embodiments, the receptacle connector contacts 62 are deflectable contacts having spring beams configured to be mated with the plug connector 100 when the plug connector 100 is plugged into the receptacle 64. Other types of contacts may be provided in alternative embodiments.

FIG. 2 is a front perspective view of the plug connector 100 in accordance with an exemplary embodiment. The plug connector 100 includes a plug housing 120 holding a contact assembly 110 and a cable assembly 104. The contact assembly 110 includes an array of contacts 112 configured to be electrically connected to the receptacle connector contacts 62 (shown in FIG. 1). The cable assembly 104 includes a plurality of the cables 102, which may be grouped or arranged together in a cable bundle. The cables 102 are terminated to corresponding contacts 112.

In various embodiments, the cables 102 are twin-axial cables each having a pair of conductors configured to be electrically connected to corresponding signal contacts 112. In an exemplary embodiment, the cables 102 include cable shields providing electrical shielding for the conductors. Other types of cables may be used in alternative embodiments, such as coaxial cables, twisted pair cables, flexible circuits, and the like.

In an exemplary embodiment, the contact assembly 110 includes an upper module 114 and a lower module 116. The upper module 114 includes upper contacts connected to corresponding upper cables and the lower module 116 includes lower contacts connected to corresponding lower cables. The upper module 114 is positioned in an upper portion of the plug housing 120 and the lower module 116 is positioned in a lower portion of the plug housing 120. Utilizing the upper and lower modules 114, 116 increases contact density within the plug connector 100 compared to the plug connector 100 including a single set of contacts and cables.

In an exemplary embodiment, the contacts 112 are formed by one or more leadframes (for example, one leadframe for the upper module 114 and one leadframe for the lower module 116). In various embodiments, the contacts 112 are stamped and formed contacts (for example, all contacts within the leadframe stamped during a single stamping process and then formed to have a particular shape, such as including one or more bends). In alternative embodiments, the contacts 112 may be conductors or circuits of a circuit board. The contacts 112 may be signal contacts, ground contacts, power contacts, and the like. In an exemplary embodiment, each contact 112 extends between a mating end and a terminating end opposite the mating end. The mating end is configured to be mated with the corresponding receptacle connector contact 62. The mating end may include a pad. In other various embodiments, the mating end may include a deflectable spring beam.

The cables 102 are terminated to the terminating ends of the contacts 112. In an exemplary embodiment, the cables 102 may be arranged in multiple rows, such as an upper row and a lower row for mating to the contacts 112 of the upper module 114 and the lower module 116, receptively.

In an exemplary embodiment, the plug housing 120 is a multi-piece housing. For example, the plug housing 120 includes a contact housing 122 configured to hold the contact assembly 110 and a cable housing 124 configured to hold the cable assembly 104. The cable housing 124 is coupled to the contact housing 122. In an exemplary embodiment, the cable housing 124 is movable relative to the contact housing 122. For example, the cable housing 124 forms a portion of the cable management device 200 and is moved to different positions to control a cable exit direction of the cables 102 from the plug housing 120.

The plug housing 120 extends between a front 130 and a rear 132. In the illustrated embodiment, the contact housing 122 is at the front 130 and the cable housing 124 is at the rear 132. The plug housing 120 has a top 134 and a bottom 136. The plug housing 120 has a first side 138 and a second side 140. In the illustrated embodiment, the front 130 defines a mating end 142 of the plug housing 120 and the rear 132 defines a cable end 144 of the plug housing 120. Other orientations are possible in alternative embodiments. The cables 102 exit the cable housing 124 of the plug housing 120 at the cable end 144 in a cable exit direction. In an exemplary embodiment, the cable management device 200 (for example, the cable housing 124) controls the cable exit direction and allows for variable cable exit directions to allow customization of the plug connector 100 within the system. For example, depending on the orientation and other components or devices around the connectors 100, 50, the cable exit direction may be selected and changed by moving the cable housing 124 relative to the contact housing 122.

In an exemplary embodiment, the contact housing 122 of the plug housing 120 includes walls 146 forming a mating cavity 148 at the mating end 142. The walls 146 may include a top wall, a bottom wall, and side walls. The walls 146 may include a front wall and/or a rear wall. The contacts 112 of the contact assembly 110 extend into the mating cavity 148 for mating with the receptacle connector 50. The mating cavity 148 may be open at the front 130 for mating with the receptacle connector 50.

In an exemplary embodiment, the cable housing 124 of the plug housing 120 includes walls 150 forming a cable cavity 152 at the cable end 144. The walls 150 may include a top wall, a bottom wall, and side walls. The walls 150 may include a front wall and/or a rear wall. The cable cavity 152 is open at the rear 132 to allow the cables 102 to exit the cable housing 124 in the cable exit direction. For example, the cables 102 pass from the rear of the contact housing 122, into the front of the cable housing 124, and exit the rear of the cable housing 124. The cables 102 extend into and/or through the cable cavity 152 for termination with the contacts 112 in the contact housing 122.

In an exemplary embodiment, the contact assembly 110 includes a contact holder 160 holding the contacts 112 and/or the cables 102. The contact holder 160 is a substrate used to hold, support and/or position the contacts 112 for mating with the receptacle connector contacts 62 of the receptacle connector 50 (shown in FIG. 1). The contact holder 160 is configured to be plugged into the receptacle 64 of the receptacle connector 50 to mate with the receptacle connector contacts 62.

In an exemplary embodiment, the contact holder 160 includes an elongated tray 162 used to support the contacts 112. The contact holder 160 includes an upper surface 164 and a lower surface 166. In an exemplary embodiment, the contacts 112 of the upper module 114 extend along the upper surface 164 and the contacts 112 of the lower module 116 extend along the lower surface 166 for mating with the receptacle connector contacts 62 (shown in FIG. 1). In an exemplary embodiment, the contact holder 160 includes pockets 168 along the upper surface 164 and the lower surface 166 that receive the contacts 112. As such, the contacts 112 may be generally flush with the upper surface 164 and the lower surface 166. In alternative embodiments, the contact holder 160 may be formed from a printed circuit board and the contacts 112 may be circuits formed on the printed circuit board.

In an exemplary embodiment, the contact holder 160 is configured to be loaded into the plug housing 120, such as through the rear 132, into the mating cavity 152. The contact holder 160 holds relative positions of the contacts 112 to allow loading of all of the contacts 112 into the plug housing 120 as a single unit. However, the contacts 112 may be loaded into the plug housing 120 individually rather than as a unit in alternative embodiments. In alternative embodiments, the contact holder 160 may be integral with the plug housing 120. For example, the contact holder 160 may be co-molded with the plug housing 120.

The plug connector 100 includes one or more guide features 170 to guide mating with the receptacle connector 50. For example, the guide features 170 may include slots 172 that receive a portion of the receptacle connector 50 to position the plug connector 100 relative to the receptacle connector 50 during mating. Other types of guide features may be used in alternative embodiments, such as rails, tabs, pins, and the like. In an exemplary embodiment, the plug connector 100 may include a securing feature, such as a latch (not shown), for latchably securing the plug connector 100 to the receptacle connector 50.

In an exemplary embodiment, the plug connector 100 includes a latch 180 configured to latchably couple the plug connector 100 to the receptacle connector 50 (shown in FIG. 1). The latch 180 is a deflectable latch movable between a latched position and an unlatched position. For example, the latch 180 may be depressed (pressed downward) to unlatch the latch 180 from the receptacle connector 50. In an exemplary embodiment, the plug connector 100 has a low profile from the mating end. In an exemplary embodiment, the latch 180 is located at the top 134 of the plug housing 120. The latch 180 may be actuated by moving the latch 180 downward to release the latching elements of the latch 180 from the receptacle connector 50.

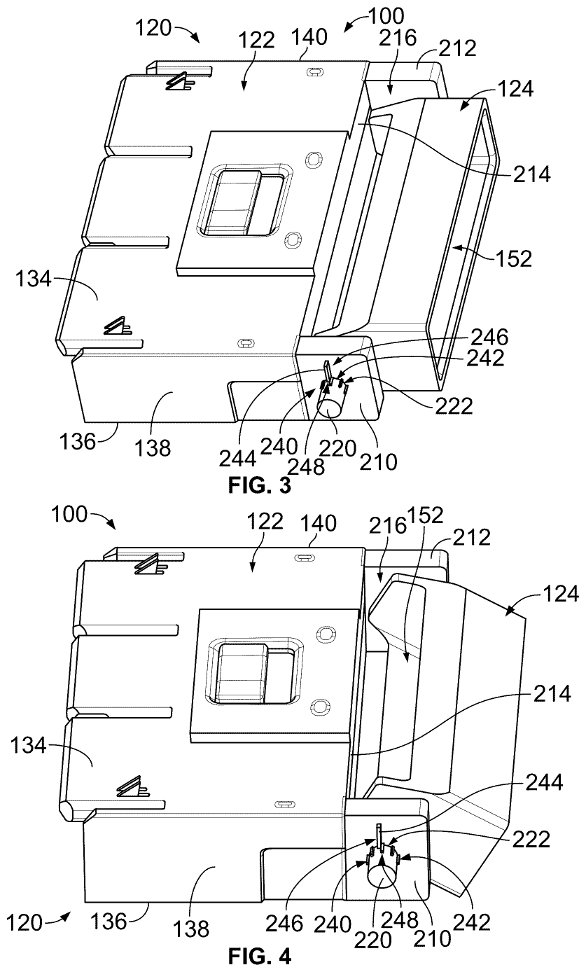

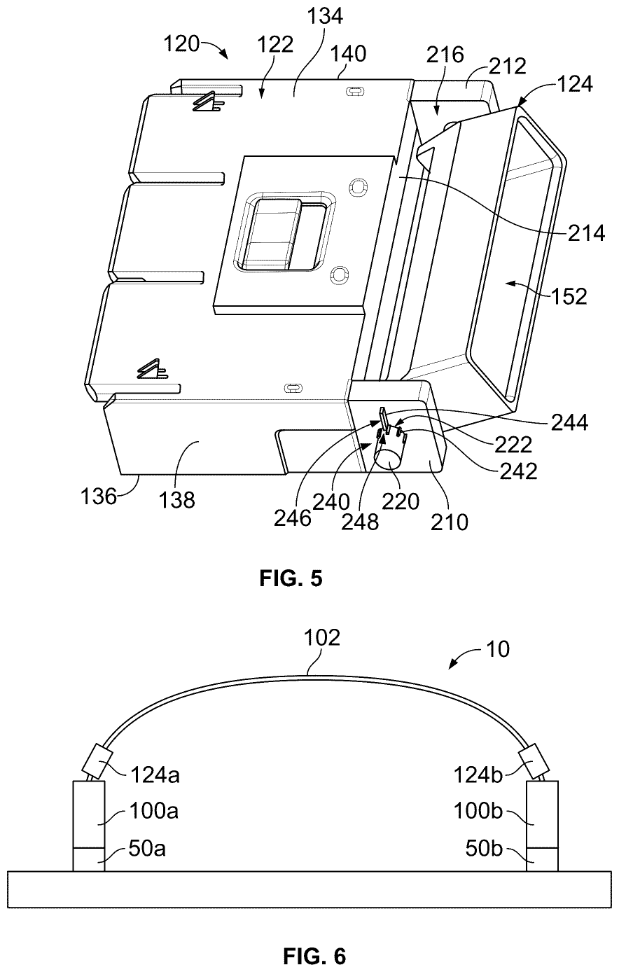

FIG. 3 is a rear perspective view of a portion of the plug housing 120 of the plug connector 100 showing the cable housing 124 in a first position relative to the contact housing 122. FIG. 4 is a rear perspective view of a portion of the plug housing 120 of the plug connector 100 showing the cable housing 124 in a second position relative to the contact housing 122. FIG. 5 is a rear perspective view of a portion of the plug housing 120 of the plug connector 100 showing the cable housing 124 in a third position relative to the contact housing 122.

The plug housing 120 is a multi-piece housing including the contact housing 122 and the cable housing 124. In an exemplary embodiment, the cable housing 124 is pivotably coupled to the contact housing 122. For example, the cable housing 124 may be pivoted or moved between various positions, such as the positions shown in FIGS. 3-5 or other relative positions to control the cable exit direction of the cables 102 (FIG. 1) from the plug housing 120. In an exemplary embodiment, the cable housing 124 is pivotable relative to the contact housing 122 to change the cable exit direction approximately 180°. For example, the cable housing 124 may be pivoted from a generally upward orientation to a generally downward orientation. The cable housing 124 may be pivoted, relative to the mating direction, to a 0° angle (FIG. 3, for example, parallel to the mating direction), a −30° angle (FIG. 4), a +30° angle (FIG. 5) or other angles, such as approximately +15°, −15°, +45°, −45°, +60°, −60°, +75°, −75°, +90°, −90° (for example, perpendicular to the mating direction) or other angular orientations to allow the cable exit in virtually any angular direction from the plug connector 100. The cables 102 pass through the cable cavity 152 of the cable housing 124 and exit from the cable housing 124 based on the angular position of the cable housing 124. The cables 102 are configured to bend in the cable cavity 152 to transition to the cable exit direction.

In an exemplary embodiment, the contact housing 122 includes hubs 210, 212 at the opposite sides 138, 140 of the contact housing 122. The hubs 210, 212 may be integral with the contact housing 122, such as being co-molded with the contact housing 122. Alternatively, the hubs 210, 212 may be separate from the contact housing 122 and coupled thereto. The hubs 210, 212 extend rearward from a rear 214 of the contact housing 122. In the illustrated embodiment, the hubs 210, 212 are rectangular. However, the hubs 210, 212 may have other shapes in alternative embodiments. The hubs 210, 212 may extend to the top 134 and/or the bottom 136.

A receiving space 216 is defined between the hubs 210, 212. In an exemplary embodiment, the cable housing 124 is received in the receiving space 216 between the hubs 210, 212. A portion of the cable housing 124 may extend into the interior cavity of the contact housing 122. The hubs 210, 212 extend along the opposite sides 138, 140 of the cable housing 124. Alternatively, the cable housing 124 may be coupled to the outer surfaces of the hubs 210, 212.

In an exemplary embodiment, pivot mechanisms 220 are provided between the hubs 210, 212 and the cable housing 124. For example, the pivot mechanisms 220 may include a fixed pivot element extending from hubs 210, 212 and/or the cable housing 124. The pivot mechanisms 220 may be pivot pins, axels, shafts, levers, hinges, ball and socket joint, trunnion bearings, crossed flexure beams, or other types of pivot mechanisms. In the illustrated embodiment, the hubs 210, 212 include openings 222 receiving pivot pins extending from the cable housing 124 defining the pivot mechanisms 220. The pivot mechanisms 220 may be integral with the cable housing 124, such as being co-molded with the cable housing 124. Alternatively, the pivot mechanisms 220 may be separate from the cable housing 124 and coupled to the cable housing 124, such as being received in openings in the cable housing 124. In other alternative embodiments, the pivot mechanisms 220 may be integral (for example, co-molded) with the contact housing 122, such as the hubs 210, 212. The pivot mechanisms 220 allow the cable housing 124 to rotate relative to the hubs 210, 212 of the contact housing 122. For example, the pivot mechanisms 220 are pivotably coupled to the hubs 210, 212 to allow pivoting of the cable housing 124 to change an angular orientation of the cable housing 124 relative to the contact housing 122.

In an exemplary embodiment, the plug housing 120 includes a locking mechanism 240 operably coupled to at least one of the contact housing 122 and the cable housing 124 to fix the cable housing 124 relative to the contact housing 122 at a locked angular orientation. The locking mechanism 240 may be released, and relocked, to change the locked angular orientation. In an exemplary embodiment, the locking mechanism 240 includes a fixed locking element 242 on one of the contact housing 122 or the cable housing 124 and a releasable locking element 244 on the other of the contact housing 122 or the cable housing 124. The releasable locking element 244 is actuated or unlocked to release from the fixed locking element 242 and allow movement of the cable housing 124 relative to the contact housing 122. The releasable locking element 244 may be released and allowed to move back to a locked position and again fix the angular position of the cable housing 124.

The locking mechanism 240 may include a pin, a latch, an opening, a clip, a fastener, a detent, or other type of locking mechanism. The locking mechanism 240 may provide bayonet locking, screw locking, snap-in locking, push-pull locking, latch locking, lever locking, and the like. The locking mechanism 240 may be spring biased to allow release of the locking mechanism 240.

In an exemplary embodiment, the locking mechanism 240 includes hub locking mechanisms 246 on the hubs 210, 212 and pivot locking mechanisms 248 on the pivot mechanisms 220. The pivot locking mechanisms 248 are configured to interface with the hub locking mechanisms 246 to fix the angular position of the pivot mechanisms 220 relative to the hubs 210, 212 at a locked angular orientation. The cable housing 124 is fixed from pivoting when the pivot locking mechanisms 248 interface with the hub locking mechanisms 246. The locking mechanism 240 may additionally or alternatively include a cable housing locking mechanism configured to interface with the pivot mechanisms 220 to fix the angular position of the pivot mechanisms 220 relative to the cable housing 124.

FIG. 6 shows an exemplary embodiment of the electrical connector system 10 in accordance with an exemplary embodiment. FIG. 6 shows a first receptacle connector 50a mounted to the circuit board 52 and a second receptacle connector 50b mounted to the circuit board 52. A first plug connector 100a is coupled to the first receptacle connector 50a. A second plug connector 100b is coupled to the second receptacle connector 50b. The cables 102 connect between the first and second plug connectors 100a, 100b.

In an exemplary embodiment, the cable housings 124a, 124b of the first and second plug connectors 100a, 100b may be angled to direct the cables 102 to transition between the first and second plug connectors 100a, 100b. The cable housings 124a, 124b may be used to limit or control cable bending of the cables 102 exiting the plug connectors 100a, 100b, such as to prevent damage to the cables 102 and/or to prevent SI performance degradation from overbending of the cables 102. The cable housings 124a, 124b improve user experience and prevent excessive cable bending by providing flexible cable transition between the plug connector 100a, 100b.

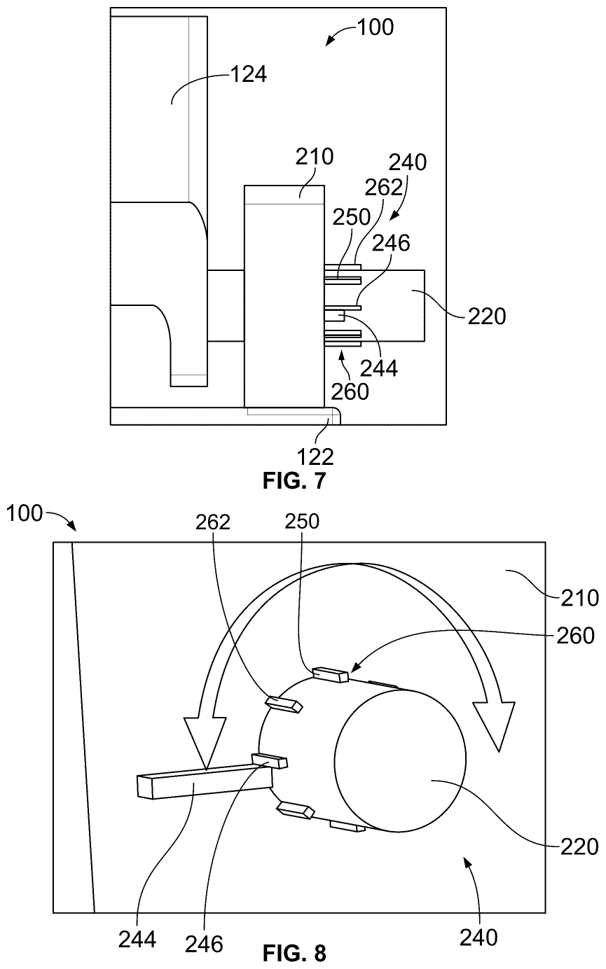

FIG. 7 is a top view of a portion of the plug connector 100 showing the locking mechanism 240 in accordance with an exemplary embodiment. FIG. 8 is a perspective view of a portion of the plug connector 100 showing the locking mechanism 240 in accordance with an exemplary embodiment. The locking mechanism 240 is used to fix the cable housing 124 relative to the contact housing 122 at a locked angular orientation. The locking mechanism 240 may be released, and relocked, to change the locked angular orientation.

In an exemplary embodiment, the locking mechanism 240 includes the hub locking mechanism 246 on the hub 210 and the pivot locking mechanism 248 on the pivot mechanism 220. The pivot locking mechanism 248 interfaces with the hub locking mechanism 246 to fix the angular position of the pivot mechanism 220 relative to the hub 210 at a locked angular orientation. The cable housing 124 is fixed from pivoting when the pivot locking mechanism 248 interfaces with the hub locking mechanism 246.

In an exemplary embodiment, the hub locking mechanism 246 defines the releasable locking element 244 and the pivot locking mechanism 248 defines the fixed locking element 242. For example, the pivot locking mechanism 248 includes protrusions, ribs, pins, latches, openings, clips or other type of locking elements that are fixed relative to the pivot mechanism 220. In the illustrated embodiment, the pivot locking mechanism 248 includes multiple elements (for example, radially extending ribs) arranged circumferentially around the pivot mechanism 220 at different radial positions.

In an exemplary embodiment, the hub locking mechanism 246 includes a releasable locking rib 250 configured to be released from the pivot locking mechanism 248. The locking rib 250 may be pressed inward, such as into the hub 210, to release from the pivot locking mechanism 248 from a locked position and an unlocked position. In other embodiments, the locking rib 250 may be slidable between a locked position and an unlocked position. In other embodiments, the locking rib 250 may be rotated between a locked position and an unlocked position. Other types of actuation may be utilized to move between the locked and unlocked positions. on one of the contact housing 122 or the cable housing 124 and a releasable locking element 244 on the other of the contact housing 122 or the cable housing 124. The releasable locking element 244 is actuated or unlocked to release from the fixed locking element 242 and allow movement of the cable housing 124 relative to the contact housing 122. The releasable locking element 244 may be released and allowed to move back to a locked position and again fix the angular position of the cable housing 124.

In an exemplary embodiment, the locking mechanism 240 includes a detent mechanism 260 operably coupled between the cable housing 124 and the contact housing 122. The detent mechanism 260 includes multiple detents 262 configured to position the cable housing 124 at different clocked angular positions. For example, the detents 262 may be ribs, rails, tabs, protrusions, pockets, slots, grooves, openings, or other types of detent features. The detent mechanism 260 may be defined by the pivot locking mechanism 248. For example, the detents 262 may be provided on the pivot mechanism 220 and interface with the hub locking mechanisms 246 to fix rotation of the pivot mechanism 220. The hub locking mechanisms 246 may be released from the detents 262 to allow pivoting of the pivot mechanism 220, and thus the cable housing 124, to a different angular position.

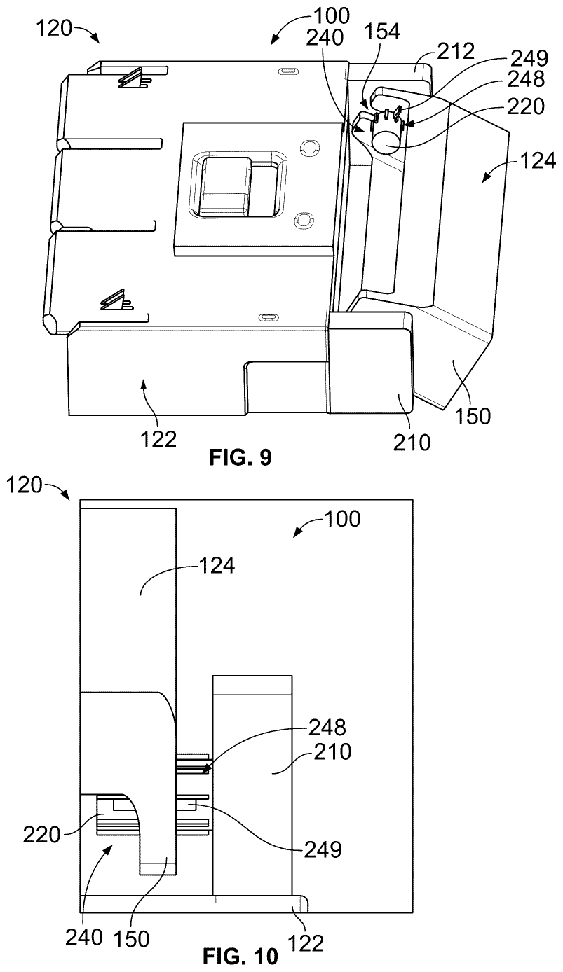

FIG. 9 is a rear perspective view of a portion of the plug housing 120 of the plug connector 100 in accordance with an exemplary embodiment. FIG. 10 is a top view of a portion of the plug connector 100 shown in FIG. 9. In the illustrated embodiment, the pivot mechanisms 220 extend from the hubs 210, 212 and are coupled to side walls 150 of the cable housing 124. The pivot mechanisms 220 extend into openings 154 formed in the side walls 150. The side walls 150 may be clipped onto the pivot mechanisms 220 to allow the cable housing 124 to pivot on the pivot mechanisms 220.

In an exemplary embodiment, the locking mechanism 240 fixes the cable housing 124 relative to the contact housing 122 at a locked angular orientation. The locking mechanism 240 may be released, and relocked, to change the locked angular orientation. In an exemplary embodiment, the cable housing 124 includes housing locking mechanisms 249 on the side walls 150 that interface with the pivot locking mechanisms 248 on the pivot mechanisms 220 to fix the angular position of the pivot mechanisms 220 relative to the cable housing 124 at a locked angular orientation.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A plug connector comprising:
a plug housing including a mating end and a cable end, the plug housing including a contact housing at the mating end and a cable housing at the cable end;
a cable assembly coupled to the cable housing, the cable assembly including cables extending from the cable end of the plug housing in a cable exit direction; and
a contact assembly coupled to the contact housing, the contact assembly including an array of contacts, each contact including a mating end and a terminating end, the mating end configured to be mated with a mating connector, the terminating end configured to be terminated to an end of a conductor of the corresponding cable;
wherein the cable housing is pivotably coupled to the contact housing to change the cable exit direction relative to the mating end.

2. The plug connector of claim 1, wherein the cable housing is pivotable relative to the contact housing to change the cable exit direction approximately 180°.

3. The plug connector of claim 1, wherein the cable housing includes a cable cavity, the cables configured to bend in the cable cavity to transition to the cable exit direction.

4. The plug connector of claim 1, wherein a portion of the cable housing is received in the contact housing.

5. The plug connector of claim 1, wherein the contact housing includes hubs at opposite sides of the contact housing, the cable housing including pivot mechanisms extending from opposite sides of the cable housing, the pivot mechanisms being pivotably coupled to the hubs to allow pivoting of the cable housing to change an angular orientation of the cable housing relative to the contact housing

6. The plug connector of claim 5, wherein the contact housing extends between a front and a rear, the hubs extending rearward from the rear of the contact housing along the sides of the cable housing.

7. The plug connector of claim 5, wherein the hubs include openings, the pivot mechanisms being received in the openings.

8. The plug connector of claim 5, wherein the hubs include hub locking mechanisms and the pivot mechanisms include pivot locking mechanisms configured to interface with the hub locking mechanisms to fix an angular position of the pivot mechanisms relative to the hubs at a locked angular orientation.

9. The plug connector of claim 1, further comprising a detent mechanism operably coupled between the cable housing and the contact housing to position the cable housing at different clocked angular positions.

10. The plug connector of claim 1, further comprising a locking mechanism operably coupled to at least one of the contact housing and the cable housing to fix the cable housing relative to the contact housing at a locked angular orientation

11. The plug connector of claim 10, wherein the locking mechanism includes a fixed locking element on one of the contact housing or the cable housing and a releasable locking element on the other of the contact housing or the cable housing

12. The plug connector of claim 1, wherein the contact assembly includes a contact holder holding the contacts relative to each other, the contact holder being coupled to the contact housing to position the contacts in the contact housing.

13. The plug connector of claim 1, wherein the contact assembly includes a circuit card having a substrate and circuits on the substrate, the circuits defining the contacts of the contact assembly.

14. The plug connector of claim 1, wherein the contact housing includes a connector latch configured to be latchably coupled to the mating connector.

15. A plug connector comprising:
a plug housing including a mating end and a cable end, the plug housing including a contact housing at the mating end and a cable housing at the cable end, wherein the cable housing is pivotably coupled to the contact housing to change an angular orientation of the cable housing relative to the contact housing;
a cable assembly coupled to the cable housing, the cable assembly including cables extending from the cable end of the plug housing in a cable exit direction based on the angular orientation of the cable housing relative to the contact housing;
a contact assembly coupled to the contact housing, the contact assembly including an array of contacts, each contact including a mating end and a terminating end, the mating end configured to be mated with a mating connector, the terminating end configured to be terminated to an end of a conductor of the corresponding cable; and
a locking mechanism operably coupled to at least one of the contact housing and the cable housing to fix the cable housing relative to the contact housing at the locked angular orientation.

16. The plug connector of claim 15, wherein the locking mechanism includes a fixed locking element on one of the contact housing or the cable housing and a releasable locking element on the other of the contact housing or the cable housing.

17. A plug connector comprising:
a plug housing including a mating end and a cable end, the plug housing including a contact housing at the mating end and a cable housing at the cable end, the contact housing including hubs at opposite sides of the contact housing, the cable housing including pivot mechanisms being pivotably between the hubs and the cable housing to allow pivoting of the cable housing to change an angular orientation of the cable housing relative to the contact housing;
a cable assembly coupled to the cable housing, the cable assembly including cables extending from the cable end of the plug housing in a cable exit direction based on the angular orientation of the cable housing relative to the contact housing; and
a contact assembly coupled to the contact housing, the contact assembly including an array of contacts, each contact including a mating end and a terminating end, the mating end configured to be mated with a mating connector, the terminating end configured to be terminated to an end of a conductor of the corresponding cable;
wherein the cable housing is pivotably coupled to the contact housing to change the cable exit direction relative to the mating end.

18. The plug connector of claim 17, wherein the contact housing extends between a front and a rear, the hubs extending rearward from the rear of the contact housing along the sides of the cable housing.

19. The plug connector of claim 17, wherein the hubs include openings, the pivot mechanisms being received in the openings.

20. The plug connector of claim 17, wherein the hubs include hub locking mechanisms and the pivot mechanisms include pivot locking mechanisms configured to interface with the hub locking mechanisms to fix an angular position of the pivot mechanisms relative to the hubs at a locked angular orientation.
